(19) United States
(12) Patent Application Publication
(10) Pub. No.: US 2026/0081681 A1
(43) Pub. Date: Mar. 19, 2026

(54) DETECTING TRANSMITTER-RECEIVER MISCONFIGURATIONS IN OPTICAL SIGNAL PATHS

(71) Applicant: Fluke Corporation, Everett, WA (US)

(72) Inventor: William F. Winston, Lake Stevens, WA (US)

(21) Appl. No.: 19/326,426

(22) Filed: Sep. 11, 2025

Related U.S. Application Data
(60) Provisional application No. 63/694,597, filed on Sep. 13, 2024.

(51) Int. Cl. H04B 10/079

(52) U.S. Cl. CPC H04B 10/079

(57) ABSTRACT

Techniques for detecting transmitter-receiver polarity misconfigurations in an optical signal path are disclosed. An apparatus for detecting polarity misconfigurations includes a light source, a transmitting port, and a photodetector. The transmitting port is configured to transmit an outgoing optical signal produced using the light source. The photodetector is in optical communication with the transmitting port and is configured to detect an incoming optical signal via the transmitting port. In some embodiments, the apparatus produces an alert in response to detecting a polarity misconfiguration.

### BACKGROUND

### Technical Field

The present disclosure relates to testing an optical signal communication path, and more particularly, to detecting a transmitter-receiver polarity misconfiguration in an optical signal communication path.

### Description of the Related Art

Fiberoptic communications are widely used for their ability to transmit high-bandwidth information over long distances. A fiberoptic communications network includes transmitters that communicate information by modulating a light signal and receivers that receive the modulated signal and convert it into an electrical signal. The transmitters and receivers are connected by cables that include optical fibers. Signal strength and distortion are often concerns in fiberoptic communication, especially where long segments of fiberoptic cable are present between a transmitter and a receiver. These cables may be expensive to repair or replace once installed. Thus, fiberoptic cables may be tested before installation, during installation, after installation, or any combination thereof. Testing may include transmitting an optical signal over the cable and determining a degree to which the signal is degraded by the cable. Fiberoptic cables containing multiple optical fibers are available in several polarities, which determine how inputs are routed to outputs of the fiberoptic cables.

### BRIEF SUMMARY

Disclosed herein are techniques for detecting a transmitter-receiver polarity misconfiguration in an optical signal communication path by detecting when a transmitting port at a first end of a fiberoptic cable receives an incoming optical signal from a transmitter at a second end of the fiberoptic cable. A transmitting port may (erroneously) receive an incoming optical signal if there is a misconfiguration of polarity in the optical signal communication path.

In some embodiments, an apparatus for detecting a polarity misconfiguration in an optical signal communication path includes a light source, a transmitting port configured to transmit an outgoing optical signal produced using the light source, and a photodetector in optical communication with the transmitting port. The photodetector is configured to detect an incoming optical signal received via the transmitting port, which indicates a polarity misconfiguration in the optical signal communication path.

### BRIEF DESCRIPTION OF THE SEVERAL VIEWS OF THE DRAWINGS

FIG. 1 illustrates a context diagram of one example of a system for detecting an optical signal communication path misconfiguration.

FIG. 2A illustrates a context diagram of one example of a system for testing a fiberoptic cable, wherein a polarity misconfiguration is not present.

FIG. 2B illustrates a context diagram of one example of a system for testing a fiberoptic cable, wherein a polarity misconfiguration is present.

FIG. 3 illustrates a logical flow diagram for a process for detecting a polarity misconfiguration while testing an optical signal communication path.

FIG. 4 illustrates a switch architecture for a system for detecting a polarity misconfiguration in an optical signal communication path.

FIG. 5 illustrates a coupler architecture for a system for detecting a polarity misconfiguration in an optical signal communication path.

FIG. 6 illustrates a system diagram that describes examples of computing systems for implementing embodiments described herein.

### DETAILED DESCRIPTION

While fiberoptic cables can be used to transmit optical signals over large distances, there are many factors that influence the performance of a fiberoptic cable. Tight bends in the cable, imperfections in fibers, poor coupler usage, dirty couplers, intrinsic attenuation losses, polarity misconfigurations, and other defects can degrade performance of a fiberoptic cable.

It is therefore known to test fiberoptic cables (i.e., “cables”) by transmitting an optical signal via the cable and evaluating the results. Cables often include several cores of optical fiber. For example, a 24 fiber multi-fiber push on (i.e., “MPO”) cable includes 24 cores of optical fiber. Often, the performance of each core of optical fiber in the MPO is evaluated. To test a cable, individual transmitters are typically connected to each fiber core and are used to transmit a test signal from a main unit through each fiber core to a remote unit. Each of the signals is received at a receiving port of the remote unit and is analyzed to determine the performance of each optical fiber core. While this technique is simple, it requires a number of transmitters and receivers equal to the number of fiber cores in the cable under test. Thus, to test a 24-fiber cable, 24 transmitters and 24 receivers would be used.

Fiberoptic communication equipment such as transmitters and receivers are typically expensive. This makes conventional testing methods as described above, wherein a different transmitter is used to test each fiber core of a multi-fiber cable, impractical in many situations. The availability of fiberoptic testing equipment is limited by these factors. Organizations unwilling or unable to invest considerable resources in fiberoptic testing may forego testing, ultimately leading to degraded network performance.

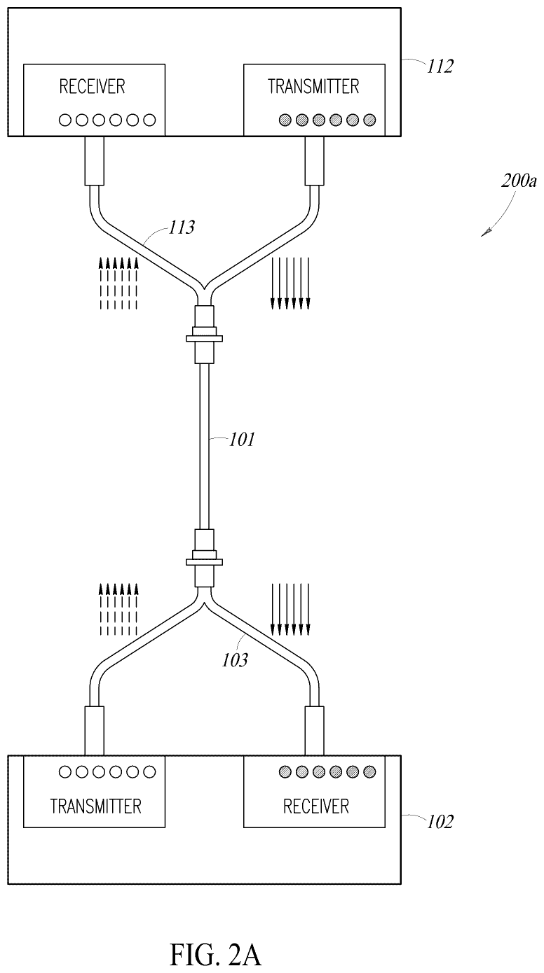

Because of the expense and inconvenience of using large numbers of transmitters and receivers in conventional testing technology, testing techniques requiring fewer transmitters and receivers are desired. The number of transmitters at the main unit and remote unit may be reduced by using a duplex configuration to test the cable, whereby data is transferred in two directions over the cable. For example, 12 receivers and 12 transmitters may be located at each end of a 24-fiber cable. The transmitters and receivers are configured such that a signal is transmitted through 12 fiber cores of the cable in a first direction, and a signal is transmitted back through the remaining 12 fiber cores of the cable in an opposite second direction. FIG. 2A illustrates an example of such a testing setup for testing a 12-fiber cable, with six transmitters and six receivers at each end of the cable.

While such techniques are lower-cost due to using fewer transmitters and receivers, there are disadvantages. The communication ports of an optical transceiver are either transmitting ports or receiving ports. Transmitting ports are not configured to receive and process an incoming optical signal. In duplex communication, each end of the cable under test is connected to a set of receiving ports and a set of transmitting ports of a main unit and a remote unit using test reference cables. It is important to ensure that signals transmitted by the transmitting ports at one end are communicated to receiving ports at the other end (i.e., polarity is correct). If, for example, the polarity of an optical signal communication path is misconfigured, a transmitting port of the main unit may erroneously be connected to a transmitting port of the remote unit, and signals sent by the transmitting port will not be received. The cable under test may therefore appear defective.

This problem is exacerbated because fiberoptic cables that are physically compatible with each other may have different polarities and connect inputs to outputs in different ways. For example, an MPO cable comes at least in Type A, Type B, and Type C polarities. Such cables may be physically compatible (i.e., connectors are similar) but their different polarities route optical signals through the cable differently. Cables are not always clearly marked with their polarity. A user testing a cable may be unaware of the different polarities or may be unsure of the polarity of the cable being tested. The user may inadvertently use test reference cables that are incompatible with the polarity of the cable being tested, and thus incorrectly connect transmitting ports of the main unit to transmitting ports of the remote unit, disrupting the test.

Techniques disclosed herein address the problem of detecting polarity misconfigurations in optical signal communication paths (e.g., fiberoptic cables) by detecting when a transmitting port receives an optical signal, which can occur when there is a polarity misconfiguration.

In some embodiments, an optical switch architecture is used to detect polarity misconfigurations. Using an optical switch, a transmitting port is communicatively coupled to a transmitting source such as a laser and a photodetector. Because optical switches can pass light bi-directionally, the optical switch can be used to selectively communicate outgoing signals from the transmitting source as well incoming signals erroneously received at the transmitting port. An optical signal received at the transmitting port is detected by the photodetector when the transmitting port is switched to the photodetector.

In some embodiments, an optical coupler architecture is used to detect polarity misconfigurations. Using an optical coupler, a transmitting port is in optical communication with a transmitting source and a photodetector. Because optical couplers can pass light bi-directionally, the optical coupler can be used to transmit outgoing optical signals from the transmitting source as well as detect incoming optical signals using the photodetector.

In some embodiments, an alert indicating a polarity misconfiguration is produced when an incoming optical signal is detected at a transmitting port.

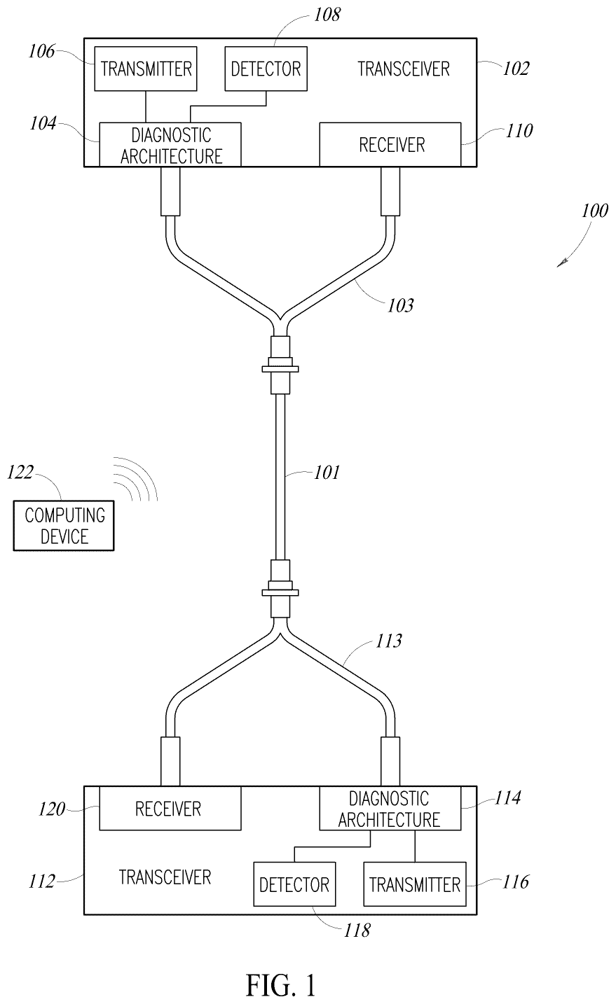

FIG. 1 illustrates a context diagram of a system 100 for detecting polarity misconfigurations in an optical signal communication path. System 100 includes transceiver 102, transceiver 112, optical cable 101, and computing device 122. Transceiver 102 may be referred to as “the main unit,” and transceiver 112 may be referred to as “the remote unit.” This distinction is made for ease of discussion; the main unit and the remote unit are not necessarily different in function.

Transceiver 102, i.e., the main unit, is an optical transceiver that includes a receiver 110 configured to receive optical signals, a transmitter 106 configured to transmit optical signals, and a detector 108 configured to detect optical signals. Transceiver 102 also includes diagnostic architecture 104, configured to route outgoing signals from transmitter 106 to a test reference cable 103, and route incoming signals from the test reference cable 103 to detector 108. Diagnostic architecture 104 therefore allows incoming optical signals to the transmitter 106 to be detected. Transceiver 102 is connected to optical cable 101 via the test reference cable 103.

Transceiver 112, i.e., the remote unit, is an optical transceiver that includes a receiver 120 configured to receive optical signals, a transmitter 116 configured to transmit optical signals, and a detector 118 configured to detect optical signals. Transceiver 112 also includes diagnostic architecture 114, configured to route outgoing signals from transmitter 116 to the test reference cable 113, and route incoming optical signals from the test reference cable 113 to the detector 118. Diagnostic architecture 114 therefore allows incoming signals to the transmitter 116 to be detected. Transceiver 112 is connected to optical cable 101 via the test reference cable 113.

When test reference cable 103, optical cable 101, and test reference cable 113 have the correct polarity, no incoming optical signal is received at diagnostic architecture 104 or diagnostic architecture 114 because all incoming optical signals are correctly routed to a receiver 110 or receiver 120, respectively. However, when test reference cable 103, optical cable 101, and test reference cable 113 do not have the correct polarity, an incoming optical signal may be received and detected using diagnostic architecture 104 and detector 108 or diagnostic architecture 114 and detector 118, respectively.

Diagnostic architecture 104 and diagnostic architecture 114 may be implemented using one or more optical switches, optical couplers, a combination thereof, or any other optical components that enable outgoing optical signals to be routed from a transmitter to an optical cable and enable incoming optical signals from the optical cable to be routed to a detector.

Computing device 122 is configured to receive an alert via transceiver 102 or transceiver 112 when a polarity misconfiguration is detected using detector 108 or detector 118, respectively. Computing device 122 may be a mobile phone, smartwatch, server, virtual machine, laptop computer, desktop computer, etc.

While detector 108, diagnostic architecture 104, receiver 110, transmitter 106, and detector 108 are depicted as distinct components of transceiver 102 for illustrative purposes, in various embodiments one or more of these components may be arranged as components of an assembly or integrated into transceiver 102. For example, the diagnostic architecture 104 may include the detector 108.

Furthermore, while the diagnostic architecture is described with respect to testing cable 101, the disclosure is not so limited. The diagnostic architecture and detector may be included in any optical transceiver in any communication network and is not limited to the use case illustrated in FIG. 1.

FIG. 2A illustrates a context diagram of a system 200a for testing a fiberoptic cable, wherein a polarity misconfiguration is not present.

As discussed herein, various optical cables may have different polarities, such as Type A, Type B, or Type C polarities. When cables having these types of polarities are mixed, a polarity misconfiguration may occur, whereby transmitting ports at the transmitting end of a communication path are connected to transmitting ports at the receiving end of the communication path.

In the example shown in FIG. 2A, test reference cable 103, cable 101, and test reference cable 113 all have the correct polarity, so there is no polarity misconfiguration. Optical signal path direction is illustrated by shading and arrow type. In the example shown in FIG. 2A, shaded transmitter ports are connected to shaded receiver ports and solid arrows indicate that there is an optical signal communication path from the transmitter of transceiver 112 to the receiver of transceiver 102. Similarly, unshaded transmitter ports are connected to unshaded receiver ports and dashed arrows indicate that there is an optical signal communication path from the transmitter of transceiver 102 to the receiver of transceiver 112. Thus, signals sent from transceiver 102 to transceiver 112 and vice versa are correctly received.

FIG. 2B illustrates a context diagram of a system 200b for testing a fiberoptic cable, wherein a typical polarity misconfiguration is caused by use of a test reference cable with incorrect polarity. In the example shown in FIG. 2B, test reference cable 103 of FIG. 2A is replaced with test reference cable 203, which has incorrect polarity. This causes a polarity misconfiguration in the optical signal communication paths between transceiver 112 and transceiver 102, whereby optical signals are routed to transmitting ports instead of receiving ports at the receiving end. Thus, optical signals that are sent by transceiver 102 or transceiver 112 are not properly received. Embodiments of the present disclosure enable detection of polarity misconfigurations such as the polarity misconfiguration in system 200b so that the polarity misconfigurations can be recognized and corrected.

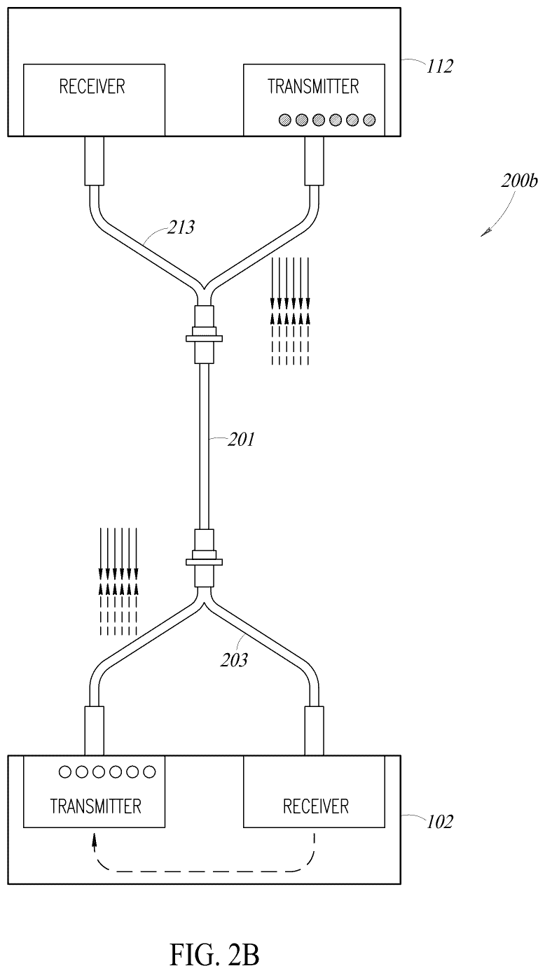

FIG. 3 illustrates a logical flow diagram for a process 300 for detecting a fiber polarity misconfiguration.

Process 300 begins, after a start block, at block 302, where an optical signal is sent from a first optical transceiver to a second optical transceiver via an optical signal communication path. The optical signal communication path may include a first test reference cord, an optical cable under test, and a second test reference cord, as previously described.

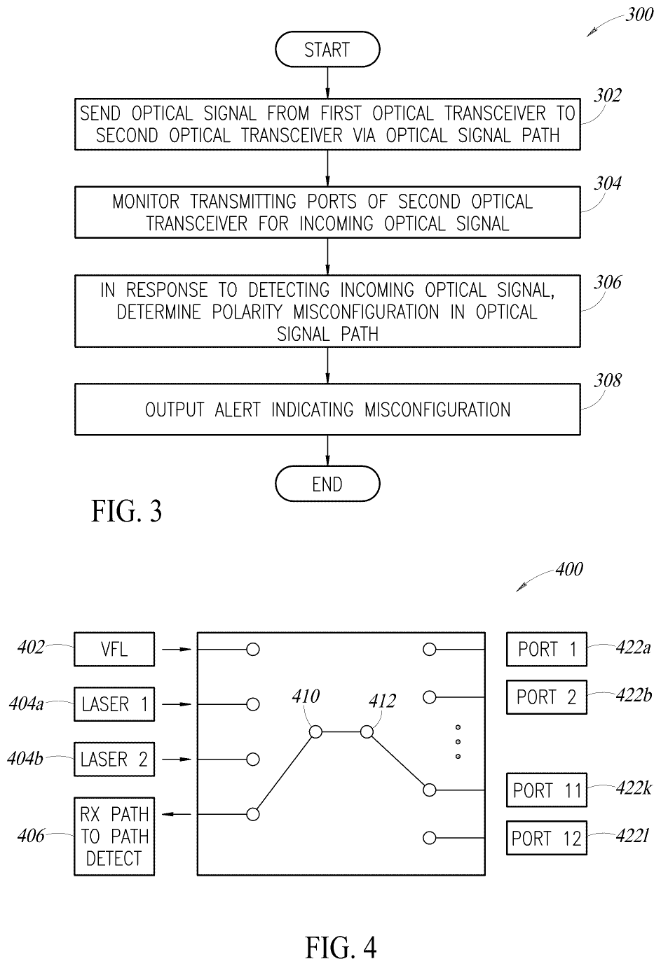

In some embodiments wherein the diagnostic architecture of a transceiver is in selective communication with a plurality of transmitting ports, such as in the switch architecture 400 shown in FIG. 4, the optical signal being received is configured to have a duration sufficient for the diagnostic architecture to place each transmitting port in optical communication with a detector. If the duration of the optical signal is too short, the switch architecture 400 and detector 406 may fail to detect the optical signal at one of the transmitting ports because switch 412 does not place the transmitting port into optical communication with detector 406 until after transmission of the optical signal has ended. Thus, the optical signal is not detected despite having been received at a transmitting port monitored by the switch architecture 400.

In some embodiments, the optical signal communication path includes a cable to be tested such as cable 101 of FIG. 1. In various embodiments, the optical signal communication path includes various connectors, cables, or combinations thereof to be tested and monitored for polarity misconfigurations as described herein. For example, an optical signal communication path being monitored for a polarity misconfiguration may be connected to a live fiberoptic network including any number of transceivers or other optical communication devices. In some embodiments, process 300 excludes block 302, such as when process 300 is used to monitor optical signal communication paths for polarity misconfigurations in a live fiberoptic network that is already sending optical signals between transceivers. After block 302, process 300 continues to block 304.

At block 304, transmitting ports of the second optical transceiver are monitored for an incoming optical signal.

In some embodiments, the transmitting ports of the second optical transceiver are monitored using a bidirectional optical switch configured to selectively route any incoming optical signals received via the transmitting ports to a photodetector. FIG. 4 depicts an example of a switch architecture for detecting incoming optical signals received via a transmitting port.

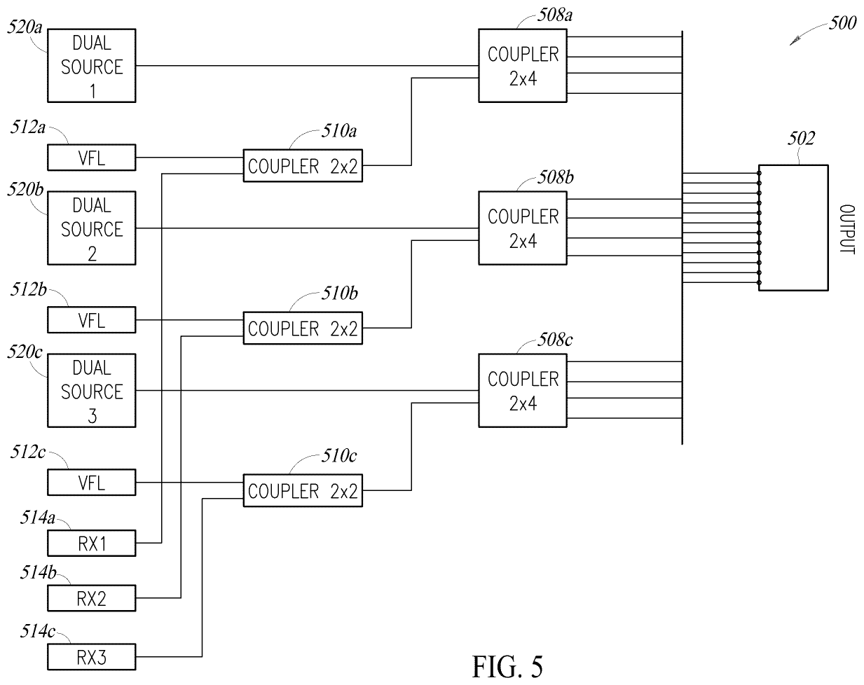

In some embodiments, the transmitting ports are monitored using an optical coupler configured to route any incoming optical signals received via the transmitting ports to a photodetector. As discussed herein, in various embodiments any number of transmitting ports are in optical communication with any number of photodetectors. In some embodiments, features of the diagnostic architecture such as the number of photodetectors are selected to enable determination of which transmitting port received an incoming optical signal. For example, coupler architecture 500 of FIG. 5 includes three detectors. Because 2³=8, eight unique combinations of photodetector activations can be detected using three detectors. Thus, up to eight groups of one or more transmitting ports may be uniquely identified based on which combination of photodetectors are activated by an incoming signal. Uniquely identifying groups of transmitting ports may enable more specific diagnosis of any polarity misconfiguration, such as by determining a type of a polarity-misconfigured connector or cable in the optical path. In some embodiments, each transmitting port may be coupled to its own detector, allowing direct determination of which transmitting port received the incoming optical signal.

In various embodiments, any suitable combination of optical couplers and optical switches may be used to detect incoming optical signals received at transmitting ports. For example, optical switch architecture 400 in FIG. 4 may include one or more optical couplers between optical switch 410 and optical switch 412, along with one or more additional optical switches connecting transmitting ports to optical switch 410 to enable multiple transmitting ports to be concurrently monitored using detector 406. In some embodiments, optical diodes are included to prevent an outgoing optical signal produced using laser 404a or laser 404b from being transmitted through multiple transmitting ports connected using optical couplers. After block 304, process 300 continues to block 306.

At block 306, a polarity misconfiguration is detected in the optical signal communication path in response to detecting an incoming optical signal at a transmitting port. In some embodiments, the polarity misconfiguration is detected in response to receiving a first optical signal at a first transmitting port. In some embodiments, the transmitting ports continue to be monitored after the first optical signal is received to determine all transmitting ports that receive incoming signals. Determining all transmitting ports that are receiving incoming optical signals may allow for more information about the polarity misconfiguration to be determined. For example, a particular polarity of a polarity-misconfigured optical cable may be determined. After block 306, process 300 continues to block 308.

At block 308, an alert is output indicating the polarity misconfiguration. In some embodiments, the alert includes a sound or light output produced by the first optical transceiver or the second optical transceiver. In some embodiments, the alert is provided to one or more computing devices such as computing device 122 of FIG. 1, which outputs sound, light, or vibration, or any combination thereof, to alert a user of the computing device.

In some embodiments, the alert provides guidance regarding how to remedy the polarity misconfiguration. As discussed herein, a cable or connector having a misconfigured polarity may be identified. The alert may identify a polarity of the misconfigured cable, a correct polarity to be used for the optical signal communication path, etc.

FIG. 4 illustrates a switch architecture 400 for a system for detecting a polarity misconfiguration in an optical signal communication path. Switch architecture 400 includes switch 410 and switch 412 and is configured to selectively place a transmitting port in optical communication with a diagnostic path. Thus, an incoming optical signal received at the transmitting port may be routed via the diagnostic path to a photodetector for detection. In various embodiments, diagnostic architecture 104 or diagnostic architecture 114 of FIG. 1 employ embodiments of switch architecture 400 to transmit outgoing optical signals and to detect incoming optical signals.

Switch 410 is in optical communication with switch 412 and in selective optical communication with a component such as visual fault light (VFL) 402, laser 404a, laser 404b, or diagnostic path 406.

In some embodiments, diagnostic path 406 is in optical communication with one or more sensors configured to detect an incoming optical signal. In various embodiments, the one or more sensors include any photodetector configured to detect the optical signal. The photodetector is not necessarily configured to determine information encoded in the optical signal. In some cases, the photodetector may be configured to receive and detect an incoming optical signal without decoding information in the optical signal because a polarity misconfiguration may be detected without determining the information encoded in the optical signal. Nonetheless, in some embodiments, the one or more sensors include an optical receiver configured to detect the optical signal and determine some or all the information encoded in the optical signal.

Switch 412 is in optical communication with switch 410 and in selective optical communication with one of transmitting ports 422a, 422b, . . . , 422k, or 422l (collectively, “transmitting ports 422”). In various embodiments, switch 412 is in selective optical communication with any number of transmitting ports such as 12 transmitting ports, 24 transmitting ports, etc.

Thus, switch 412 may be used to selectively place a transmitting port in optical communication with switch 410. Switch 410, in turn, may be used to selectively place a component in optical communication with the selected transmitting port.

As illustrated in FIG. 4, switch architecture 400 is configured to selectively place one of transmitting ports 422 into communication with VFL 402, laser 404a, laser 404b, or detection path 406. In this example, a transmitting port is not concurrently connected to a laser such as laser 404a and detection path 406. Similarly, multiple transmitting ports are not concurrently connected to detection path 406. To monitor the various transmitting ports, switch 410 is placed in optical communication with detection path 406, and switch 412 is selectively placed into optical communication with the various transmitting ports to monitor the transmitting ports for incoming optical signals. In various embodiments, any sequence of transmitting ports, switching frequency, or both, is used to selectively place the transmitting ports 422 into optical communication with detection path 406. For example, the switch 412 may selectively connect to the transmitting ports in a configurable order such as starting from transmitting port 422a and proceeding in order to transmitting port 422l. In some embodiments, the transmitting ports are selectively placed in communication with detection path 406 in a loop until an incoming optical signal is detected or until a time period for monitoring the transmitting ports has concluded. In some such embodiments, iteration through the transmitting ports continues for a configurable amount of time or number loops after an incoming optical signal is detected to determine whether an incoming optical signal is received at other transmitting ports.

The transmitting ports are not necessarily placed in communication with detection path 406 in a sequence or loop. In some embodiments, each transmitting port is periodically placed in communication with detection path 406.

In some embodiments, additional optical switches, optical couplers, or both, are included in switch architecture 400 to enable multiple transmitting ports to be concurrently monitored.

Because switch architecture 400 as illustrated in FIG. 4 only contains two optical switches, it can easily and cost-effectively be implemented in optical transceivers used for diagnostic purposes such as testing a cable, or in optical transceivers that may not require continuous transmission. But because switch architecture 400 does not support concurrent transmission and detection, it may be less suitable for use in transceivers requiring continuous use of transmitting ports or high-bandwidth applications requiring high uptime for multiple transmitting lasers.

FIG. 5 illustrates a coupler architecture 500 for a system for detecting a transmitter-receiver polarity misconfiguration. Coupler architecture 500 includes one or more optical couplers such as optical couplers 510a, 510b, 510c, and optical couplers 508a, 508b, and 508c configured to place one or more transmitting ports in optical communication with one or more detectors such as detector (RX) 514a, 514b, or 514c (collectively, “detectors 514”). Transmitters such as “dual source” transmitters 520a, 520b, and 520c (collectively, “transmitters 520”) are configured to transmit optical signals. Visual fault indicators 512a, 512b, and 512c (collectively, “VFLs 512”) are configured to transmit visible light to enable manual troubleshooting of coupler architecture 500 or other optical components in optical communication with coupler architecture 500. Output 502 includes one or more transmitting ports (not shown).

An incoming optical signal is received via a transmitting port of output 502. Coupler architecture 500 routes the incoming optical signal received via one of the transmitting ports to one or more of detectors 514a, 514b, or 514c. Coupler architecture 500 is designed to identify a one or more transmitting ports that receive an incoming optical signal by optically coupling groups of one or more transmitting ports to one or more detectors.

To illustrate how an incoming optical signal is routed to one or more of detectors 514, an example optical signal path between a transmitting port of output 502 and detector 514a is described. An incoming optical signal received at coupler 508a via a transmitting port of output 502. Coupler 508a routes the incoming optical signal to coupler 510a. Coupler 510a routes the incoming optical signal to visual fault indicator 512a and detector 514a. Thus, an incoming optical signal received at any of the four transmitting ports in optical communication with coupler 508a is detected using detector 514a. Similarly, an incoming optical signal received at coupler 508b is detected using detector 514b, and an incoming optical signal received at coupler 508c is detected using detector 514c.

Optical couplers such as coupler 510a, in this example, are 2×2 optical couplers having two inputs and two outputs. An optical signal received at an input of an optical coupler is split between each of the outputs. Optical couplers are bidirectional, meaning optical signals received at an output of the optical coupler will also be split between each of the inputs of the optical coupler. Thus, an incoming optical signal received at coupler 510a via a transmitting port of output 502 is transmitted via coupler 510a to VFL 512a and detector 514a.

The coupler architecture 500 illustrated in the example shown in FIG. 5 places three groups of four transmitting lines into optical communication with one of three separate detectors, such that detecting an incoming optical signal using a detector indicates that the incoming optical signal was received by at least one of four corresponding transmitting ports. But the disclosure is not necessarily limited to detecting incoming optical signals received via a group of transmitting ports using one detector. In various embodiments, groups of one or more transmitting ports are routed to combinations of one or more detectors. In one non-limiting example, six groups of two transmitting ports are in optical communication with six unique combinations of three detectors. For example, two transmitting ports in optical communication with coupler 508a are in optical communication with detector 514a and 514c (not shown). Thus, detecting an incoming optical signal using both detector 514a and detector 514c indicates that the incoming optical signal was received via at least one transmitting port in the group of two transmitting ports. Continuing the example, a second group of two transmitting ports is routed to detector 514a only. Thus, detecting an incoming optical signal only using detector 514a indicates that the incoming optical signal was received via at least one transmitting port in the second group of two transmitting ports. Similar architectures may be used to monitor any number of transmitting ports or groups thereof. In various embodiments according to coupler architecture 500, ┌√N┐ detectors can be used to uniquely identify N groups of one or more transmitting ports. For example, 12 groups of one or more transmitting ports may be uniquely identified using ┌√12┐=┌3.46┐=4 detectors using an architecture similar to coupler architecture 500.

In some applications, it is not necessary to distinguish which transmitting port received an incoming optical signal because any transmitting port receiving an optical signal indicates a misconfiguration. As a result, the mapping between transmitting ports and diagnostic paths may be determined by application-specific needs or the cost of the components required to implement the coupler architecture.

In various embodiments, coupler architecture 500 places any number of transmitting lines in optical communication with any number of detectors 514. For example, in applications where it is important to uniquely distinguish a transmitting port that receives an incoming optical signal, each transmitting port may optically communicate with a unique combination of detectors such that a transmitting port receiving an incoming optical signal is identified. In some embodiments, several transmitting ports optically communicate with detectors in a many-to-one correspondence. For example, all transmitting ports may be in optical communication with one detector.

While architecture 500 is depicted as including various visual fault indicators (VFLs) such as VFL 512, in various embodiments one or more of the visual fault indicators and their corresponding couplers may not be present. For example, VFL 512a and coupler 510a may be removed, and coupler 508a is placed in direct optical communication with detector 514a instead of communicating with detector 514a via coupler 510a.

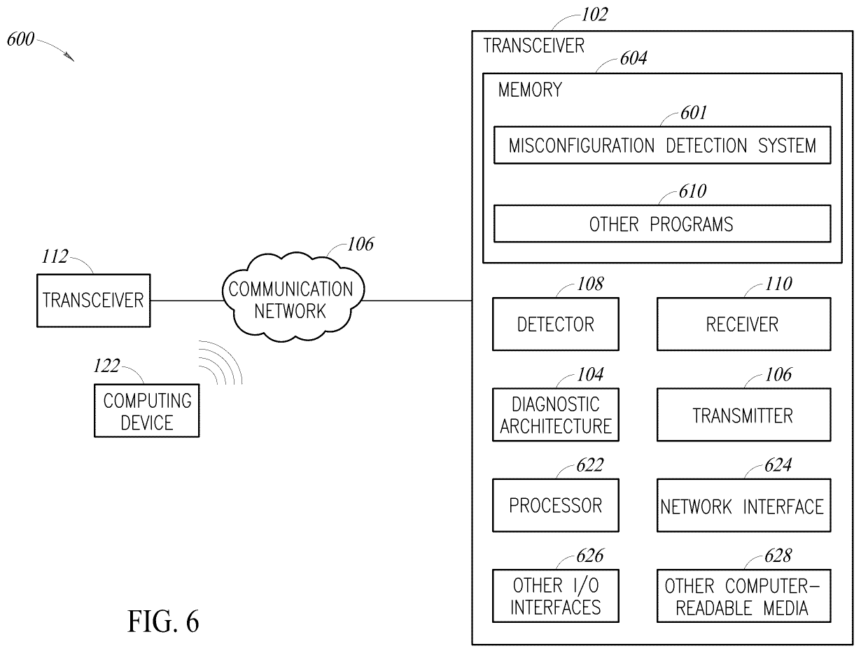

FIG. 6 illustrates a system diagram that describes examples of computing systems 600 for implementing embodiments described herein for detecting and reporting a misconfiguration in an optical signal communication path, e.g., between a communication network 606 and a transceiver 102.

Computing systems 600 include transceiver 102, transceiver 112, and computing device 122, which may communicate with each other or other devices via communication network 606.

Transceiver 102 includes diagnostic architecture 104, transmitter 106, detector 108, receiver 110, memory 604, processor 622, network interface 624, other I/O interfaces 626, and other computer-readable media 628. In some cases, transmitter 106 and receiver 110 may be implemented within the network interface 624. Memory 604 includes misconfiguration detection system 601 and other programs 610.

Transceiver 102 is a computing system or environment that detects communication path misconfigurations, such as a polarity misconfiguration as described herein. One or more special-purpose computing systems may be used to implement transceiver 102. Accordingly, various embodiments described herein may be implemented in software, hardware, firmware, or in some combination thereof.

Transmitter 112 is configured to communicate with transceiver 102 via the communication network 606. Diagnostic architecture 104 in the transceiver 102 is configured to enable detection of incoming optical signals erroneously received at transmitter 106 by routing the incoming optical signals to detector 108. Diagnostic architecture 104 may be implemented using optical switches as shown in FIG. 4, optical couplers as shown in FIG. 5, or using any other suitable optical signal communication components. The detector 108 may be a separate component as shown, or may be integrated into the diagnostic architecture 104. Receiver 110 is configured to receive incoming optical signals.

Processor 622 may include one or more central processing units, circuitry, or other computing components or units - collectively referred to as a processor or one or more processors - that are configured to performed embodiments herein or to execute computer instructions to perform embodiments described herein. Such computer instructions may be programmed in the misconfiguration detection system 601. In some embodiments, a single processor may operate individually to perform embodiments described herein. In other embodiments, a plurality of processors may operate to collectively perform embodiments described herein, such that one or more processors may operate to perform some, but not all, of the embodiments described herein.

Memory 604 may include one or more various types of non-volatile and/or volatile storage technologies. Examples of memory 604 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof.

Memory 604 may be utilized to store information, including computer-readable instructions that are utilized by processor 622 to perform actions, including embodiments for detecting communication path misconfiguration as described herein.

Memory 604 may have stored thereon misconfiguration detection system 601, which produces alerts indicating that there is a polarity misconfiguration when an incoming optical signal is detected using detector 108. In some embodiments, misconfiguration detection system 601 determines a polarity of the optical signal communication path based on the incoming optical signal. In various embodiments, misconfiguration detection system 601 produces alerts notifying various entities associated with a cable that there is a polarity misconfiguration in the optical signal communication path. The alert may include sending a notification to computing device 122, which may be a cell phone, computer, smart watch, etc. In some embodiments, the alert includes outputting a light, sound, or other output using other I/O interfaces 626.

Network interface 624 is configured to communicate with other computing devices, such as computing device 122. I/O interfaces 548 may include one or more data input or output interfaces, video or display interfaces, lights, speakers, or other input/output interfaces. Other computer-readable media 628 may include other types of computer-readable media, such as removable flash drives, external hard drives, etc.

The computing device 122 may include processors, memory, I/O interfaces, network connections, or other computing components, but are not shown in FIG. 6 for ease of discussion.

Various embodiments of apparatus, systems, and methods for a detecting polarity misconfiguration in optical signal paths may include any of the features described herein, in any combination.

By way of example, embodiments of the present disclosure may include apparatus having one or more transmitting ports configured to transmit an outgoing optical signal. The apparatus may further include one or more photodetectors in optical communication with at least one of the transmitting ports. The one or more photodetectors are configured to detect an incoming optical signal received via one or more of the transmitting ports. Optionally, the apparatus may include a light source configured to transmit outgoing optical signals via the one or more transmitting ports.

In various embodiments, the apparatus may optionally include a bidirectional optical switch configured to selectively route incoming optical signals received by one or more of the transmitting ports to the one or more photodetectors. The bidirectional optical switch may also be configured to selectively route outgoing optical signals to the transmitting ports, for example as produced by a light source.

In various embodiments, the apparatus may optionally include an optical coupler configured to route incoming optical signals received by one or more of the transmitting ports to the one or more photodetectors. The optical coupler may also be configured to selectively route outgoing optical signals produced using the light source to the transmitting ports.

In various embodiments, the apparatus may optionally include one or more processors and a storage device that stores instructions executable by the one or more processors. When executed, the instructions may cause the one or more processors to detect, using the one or more photodetectors, an incoming optical signal. Optionally, in response to detecting the incoming optical signal, the one or more processors may output an alert indicating that a polarity misconfiguration has been detected.

In various embodiments, the apparatus may optionally be configured with at least first and second transmitting ports configured to transmit outgoing optical signals, for example as produced using the light source. Optionally, the apparatus may further comprise one or more optical couplers, wherein the one or more optical couplers are configured to route incoming optical signals received by the first and/or second transmitting port to the one or more photodetectors. The one or more optical couplers may also be configured to route outgoing optical signals, e.g., as produced using the light source, to the first and/or second transmitting ports.

In various embodiments in which the apparatus includes first and second transmitting ports, the apparatus may optionally include one or more bidirectional optical switches configured to selectively route incoming optical signals received by the first and/or second transmitting port to the one or more photodetectors. The one or more bidirectional optical switches may also be configured to selectively route outgoing optical signals, e.g., as produced using the light source, to the first and/or second transmitting ports.

In various embodiments, the apparatus may optionally include an optical switch in selective optical communication with each of a plurality of transmitting ports and be configured to communicate, e.g., periodically, with each transmitting port to detect an incoming optical signal.

By way of example, embodiments of the present disclosure may include a system comprising a transmitting port configured to transmit an optical signal produced by a light source, and a photodetector configured to detect an optical signal received by the transmitting port.

In various embodiments, the system may optionally include an optical switch and/or an optical coupler configured to route the optical signal received by the transmitting port to the photodetector.

In various embodiments, the system may optionally include one or more processors, and a storage device that stores instructions executable by the one or more processors. When executed the instructions cause the one or more processors to detect, using the photodetector, the optical signal received by the transmitting port. In response to detecting the optical signal, the one or more processors may determine a polarity misconfiguration in the system.

In various embodiments, the system optionally includes a second transmitting port configured to transmit an optical signal and a photodetector configured to detect an optical signal received by the second transmitting port. A bidirectional optical switch and/or an optical coupler may be configured to route the optical signal received by the transmitting port or the second transmitting port to the photodetector.

By way of example, embodiments of the present disclosure may include a method that, for example, comprises transmitting an optical signal from a first optical transceiver to a second optical transceiver via an optical signal path. Optionally, the method includes monitoring the one or more transmitting ports for the optical signal. Such monitoring may use a photodetector in optical communication with one or more transmitting ports of the second optical transceiver. In response to detecting the optical signal, the method optionally includes determining a misconfiguration in the optical signal path and, in cases, outputting an alert indicating the misconfiguration.

In various embodiments in which the one or more transmitting ports are a plurality of transmitting ports and/or the one or more photodetectors are a plurality of photodetectors, monitoring the one or more transmitting ports for the optical signal may include monitoring the plurality of transmitting ports for the optical signal using the plurality of photodetectors in optical communication with the plurality of transmitting ports. In some cases, the one or more photodetectors is a photodetector in selective optical communication with each transmitting port of the plurality of transmitting ports, and the method includes monitoring the one or more transmitting ports for the optical signal by periodically connecting each transmitting port to the photodetector using one or more optical switches, and using the photodetector to monitor the plurality of transmitting ports for the optical signal.

In various embodiments, the one or more photodetectors are optionally in selective optical communication with the one or more transmitting ports of the second optical receiver by way of one or more optical switches. In such embodiments, the method optionally further includes selecting a transmitting port in the one or more transmitting ports to monitor for the optical signal by placing the transmitting port in optical communication with the photodetector using the one or more optical switches.

In various embodiments, the photodetector is optionally in optical communication with the one or more transmitting ports of the second optical receiver by way of one or more optical couplers. In such embodiments, the method optionally further includes detecting the optical signal while the one or more transmitting ports are transmitting a second optical signal.

In various embodiments, the method may comprise, in response to detecting the optical signal, determining a type of an optical cable in the optical signal path based on which of the one or more transmitting ports received the optical signal, and optionally outputting the alert which includes outputting the type of the optical cable.

Thus, in view of the foregoing description, one or more specific examples of the disclosure may include the following. In at least one example, an apparatus comprises a light source; one or more transmitting ports configured to transmit an outgoing optical signal produced using the light source; and one or more photodetectors in optical communication with a transmitting port of the one or more transmitting ports, wherein the one or more photodetectors are configured to detect an incoming optical signal received via the transmitting port.

In the preceding example, the apparatus optionally further comprises a bidirectional optical switch configured to selectively route incoming optical signals received via the transmitting port to the one or more photodetectors, and to selectively route outgoing optical signals produced using the light source to the transmitting port.

In any of the preceding examples, the apparatus optionally further comprises an optical coupler configured to route incoming optical signals received via the transmitting port to the one or more photodetectors and to route outgoing optical signals produced using the light source to the transmitting port.

In any of the preceding examples, the apparatus optionally further comprises one or more processors and a storage device that stores instructions executable by the one or more processors to cause the one or more processors to: detect, using the one or more photodetectors, the incoming optical signal, and in response to detecting the incoming optical signal, output an alert that a polarity misconfiguration has been detected.

In any of the preceding examples, the transmitting port may be a first transmitting port, and the apparatus further comprises: a second transmitting port configured to transmit an outgoing optical signal produced using the light source, and one or more optical couplers, wherein the one or more optical couplers are configured to route incoming optical signals received via the first transmitting port and the second transmitting port to the one or more photodetectors and to route outgoing optical signals produced using the light source to the first transmitting port and the second transmitting port.

In any of the preceding examples, the transmitting port may be a first transmitting port, and the apparatus further comprises: a second transmitting port configured to transmit an outgoing optical signal, and one or more bidirectional optical switches configured to selectively route incoming optical signals received via the transmitting port or the second transmitting port to the one or more photodetectors, and to selectively route outgoing optical signals produced using the light source to the transmitting port or the second transmitting port.

In any of the preceding examples, the apparatus optionally further comprises a second transmitting port configured to transmit an outgoing optical signal produced using the light source, wherein the second transmitting port is optically coupled with the one or more photodetectors.

In any of the preceding examples, the one or more transmitting ports are a plurality of transmitting ports, and the apparatus further comprises an optical switch in selective optical communication with each of the transmitting ports and configured to periodically communicate with each transmitting port to detect the incoming optical signal.

In another example of the present disclosure, a system comprises a transmitting port configured to transmit an optical signal produced by a light source, and a photodetector configured to detect an optical signal received via the transmitting port.

In the preceding example, the system optionally further comprises an optical switch configured to route the optical signal received via the transmitting port to the photodetector.

In any of the preceding examples, the system optionally further comprises an optical coupler configured to route the optical signal received via the transmitting port to the photodetector.

In any of the preceding examples, the system optionally further comprises one or more processors, and a storage device that stores instructions executable by the one or more processors to cause the one or more processors to detect, using the photodetector, the optical signal received via the transmitting port, and in response to detecting the optical signal, determine a polarity misconfiguration in the system.

In any of the preceding examples, the system optionally further comprises a second transmitting port configured to transmit an optical signal; a photodetector configured to detect an optical signal received via the second transmitting port; and an optical coupler configured to route the optical signal received via the transmitting port or the second transmitting port to the photodetector.

In any of the preceding examples, the system optionally further comprises a second transmitting port configured to transmit an optical signal; a photodetector configured to detect an optical signal received via the second transmitting port; and a bidirectional optical switch configured to selectively route the optical signal received via the transmitting port or the second transmitting port to the photodetector.

In another yet example of the present disclosure, a method comprises transmitting an optical signal from a first optical transceiver to a second optical transceiver via an optical signal path; monitoring, using a photodetector in optical communication with one or more transmitting ports of the second optical transceiver, the one or more transmitting ports for the optical signal; in response to detecting the optical signal, determining a misconfiguration in the optical signal path; and outputting an alert indicating the misconfiguration.

In the preceding example, the one or more transmitting ports may be a plurality of transmitting ports, the one or more photodetectors may be a plurality of photodetectors, and monitoring the one or more transmitting ports for the optical signal may comprise monitoring, using the plurality of photodetectors in optical communication with the plurality of transmitting ports, the plurality of transmitting ports for the optical signal.

In any of the preceding examples, the one or more transmitting ports may be a plurality of transmitting ports; the one or more photodetectors may comprise a photodetector in selective optical communication with each transmitting port of the plurality of transmitting ports, and the monitoring the one or more transmitting ports for the optical signal may comprise periodically connecting each transmitting port to the photodetector using one or more optical switches, and monitoring, using the photodetector, the plurality of transmitting ports for the optical signal.

In any of the preceding examples, the one or more photodetectors may be in selective optical communication with the one or more transmitting ports of the second optical receiver via one or more optical switches, and the method may further comprise selecting a transmitting port in the one or more transmitting ports to monitor for the optical signal by placing the transmitting port in optical communication with the photodetector using the one or more optical switches.

In any of the preceding examples, the photodetector is in optical communication with the one or more transmitting ports of the second optical receiver via one or more optical couplers, and the method further comprises detecting the optical signal while the one or more transmitting ports are transmitting a second optical signal.

In any of the preceding examples, the method optionally further includes, in response to detecting the optical signal, determining a type of an optical cable in the optical signal path based on which of the one or more transmitting ports received the optical signal, and outputting the alert includes outputting the type of the optical cable.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An apparatus comprising:
a light source;
one or more transmitting ports configured to transmit an outgoing optical signal produced using the light source; and
one or more photodetectors in optical communication with a transmitting port of the one or more transmitting ports, wherein the one or more photodetectors are configured to detect an incoming optical signal received via the transmitting port.

2. The apparatus of claim 1, further comprising:
a bidirectional optical switch configured to selectively route incoming optical signals received via the transmitting port to the one or more photodetectors, and to selectively route outgoing optical signals produced using the light source to the transmitting port.

3. The apparatus of claim 1, further comprising:
an optical coupler configured to route incoming optical signals received via the transmitting port to the one or more photodetectors and to route outgoing optical signals produced using the light source to the transmitting port.

4. The apparatus of claim 1, further comprising:
one or more processors; and
a storage device that stores instructions executable by the one or more processors to cause the one or more processors to:
detect, using the one or more photodetectors, the incoming optical signal; and
in response to detecting the incoming optical signal, output an alert that a polarity misconfiguration has been detected.

5. The apparatus of claim 1, wherein the transmitting port is a first transmitting port, the apparatus further comprising:
a second transmitting port configured to transmit an outgoing optical signal produced using the light source; and
one or more optical couplers, wherein the one or more optical couplers are configured to route incoming optical signals received via the first transmitting port and the second transmitting port to the one or more photodetectors and to route outgoing optical signals produced using the light source to the first transmitting port and the second transmitting port.

6. The apparatus of claim 1, wherein the transmitting port is a first transmitting port, the apparatus further comprising:
a second transmitting port configured to transmit an outgoing optical signal; and
one or more bidirectional optical switches configured to selectively route incoming optical signals received via the transmitting port or the second transmitting port to the one or more photodetectors, and to selectively route outgoing optical signals produced using the light source to the transmitting port or the second transmitting port.

7. The apparatus of claim 1, further comprising:
a second transmitting port configured to transmit an outgoing optical signal produced using the light source, wherein the second transmitting port is optically coupled with the one or more photodetectors.

8. The apparatus of claim 1, wherein the one or more transmitting ports are a plurality of transmitting ports, the apparatus further comprising:
an optical switch in selective optical communication with each of the transmitting ports and configured to periodically communicate with each transmitting port to detect the incoming optical signal.

9. A system comprising:
a transmitting port configured to transmit an optical signal produced by a light source; and
a photodetector configured to detect an optical signal received via the transmitting port.

10. The system of claim 9, further comprising:
an optical switch configured to route the optical signal received via the transmitting port to the photodetector.

11. The system of claim 9, further comprising:
an optical coupler configured to route the optical signal received via the transmitting port to the photodetector.

12. The system of claim 9, further comprising:
one or more processors; and
a storage device that stores instructions executable by the one or more processors to cause the one or more processors to:
detect, using the photodetector, the optical signal received via the transmitting port; and
in response to detecting the optical signal, determine a polarity misconfiguration in the system.

13. The system of claim 9, further comprising:
a second transmitting port configured to transmit an optical signal;
a photodetector configured to detect an optical signal received via the second transmitting port; and
an optical coupler configured to route the optical signal received via the transmitting port or the second transmitting port to the photodetector.

14. The system of claim 9, further comprising:
a second transmitting port configured to transmit an optical signal;
a photodetector configured to detect an optical signal received via the second transmitting port; and
a bidirectional optical switch configured to selectively route the optical signal received via the transmitting port or the second transmitting port to the photodetector.

15. A method comprising:
transmitting an optical signal from a first optical transceiver to a second optical transceiver via an optical signal path;
monitoring, using a photodetector in optical communication with one or more transmitting ports of the second optical transceiver, the one or more transmitting ports for the optical signal;
in response to detecting the optical signal, determining a misconfiguration in the optical signal path; and
outputting an alert indicating the misconfiguration.

16. The method of claim 15, wherein the one or more transmitting ports are a plurality of transmitting ports, the one or more photodetectors are a plurality of photodetectors, and monitoring the one or more transmitting ports for the optical signal comprises:
monitoring, using the plurality of photodetectors in optical communication with the plurality of transmitting ports, the plurality of transmitting ports for the optical signal.

17. The method of claim 15, wherein:
the one or more transmitting ports are a plurality of transmitting ports;
the one or more photodetectors is a photodetector in selective optical communication with each transmitting port of the plurality of transmitting ports, and
the monitoring the one or more transmitting ports for the optical signal comprises:
periodically connecting each transmitting port to the photodetector using one or more optical switches; and
monitoring, using the photodetector, the plurality of transmitting ports for the optical signal.

18. The method of claim 15, wherein the one or more photodetectors are in selective optical communication with the one or more transmitting ports of the second optical receiver via one or more optical switches, the method further comprising:
selecting a transmitting port in the one or more transmitting ports to monitor for the optical signal by placing the transmitting port in optical communication with the photodetector using the one or more optical switches.

19. The method of claim 15, wherein the photodetector is in optical communication with the one or more transmitting ports of the second optical receiver via one or more optical couplers, the method further comprising:
detecting the optical signal while the one or more transmitting ports are transmitting a second optical signal.

20. The method of claim 15, further comprising:
in response to detecting the optical signal, determining a type of an optical cable in the optical signal path based on which of the one or more transmitting ports received the optical signal; and
wherein outputting the alert includes outputting the type of the optical cable.
